(19) United States
(12) Patent Application Publication
(10) Pub. No.: US 2004/0017915 A1
(43) Pub. Date: Jan. 29, 2004

(54) Detector and method for detecting copy-protection signal

(75) Inventor: Shuichi Hisatomi, Fuchu-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/456,553

(22) Filed: Jun. 9, 2003

(30) Foreign Application Priority Data
Jul. 29, 2002 (JP) 2002-219093

(51) Int. Cl. H04N 7/167

(52) U.S. Cl. 380/202

(57) ABSTRACT

A pseudo-synchronization pulse detecting section detects a pseudo-synchronization pulse from a horizontal scanning line signal during a vertical blanking period of an entered analog video signal. A pseudo-AGC pulse detecting section detects a pseudo-AGC pulse from the horizontal scanning line signal during the vertical blanking period. A determining section determines whether a copy-protection signal is actually contained or not in the analog video signal, i.e., whether the video signal is protected or not, based on detection results of the pseudo-synchronization pulse detecting section and the pseudo-AGC pulse detecting section.

### CROSS-REFERENCE TO RELATED APPLICATIONS

This application is based upon and claims the benefit of priority from the prior Japanese Patent Application No. 2002-219093, filed Jul. 29, 2002, the entire contents of which are incorporated herein by reference.

### BACKGROUND OF THE INVENTION

1. Field of the Invention

This invention relates to a detector and a method which detect presence of a copy-protection signal inserted to prevent copying among, for example analog video signals of a recorded tape on which video software such as a movie has been recorded.

2. Description of the Related Art

It is necessary for a home VTR to make substantially impossible copying (so-called dubbing) of the recorded video tape on which the video software such as a movie has been recorded. Thus, a movie company makes video software by giving copy protection of one kind or another to a video signal recorded on a video tape. Thereby, the video software is copy-protected.

There are a plurality of copy protection systems. It is common for all the methods to realize copy protection by intentionally causing a malfunction of an auto gain control (AGC) circuit disposed in a video input processing circuit of an analog video recorder.

As an example of a copy-protection signal inserted into such an analog video signal, a system is disclosed in Japanese Patent Application KOKAI Publication No. 5-191771. According to the system of this publication, copy-protection signals in which five pairs of pseudo-synchronization pulses and pseudo-AGC pulses are continuously set are inserted into five continuous scanning lines during a vertical blanking period. The copy-protection signals are inserted during the vertical blanking period, because there is a fear that direct insertion of the copy-protection signals into picture portions of the video signal may damage a content itself of the video software.

If there are copy-protection signals inserted into the analog video signal, the auto gain control (AGC) circuit disposed in the VTR recording system changes a gain of the video signal in accordance with the pseudo-AGC pulse. As a result, a recorded video is unnaturally changed in, for example brightness to become unworthy of appreciation. Additionally, normal synchronization of the video becomes impossible by the pseudo-synchronization pulse.

Recently, a digital video signal recorder has become popular, which converts an analog video signal into a digital signal and compresses the digital signal to record it on an HDD or a DVD. Also in such a recorder, copy-protected video software should not be recorded. Even if the copy-protected video software is recorded by using such a recorder, the video is not recorded normally because of the pseudo-AGC pulse or the pseudo-synchronization pulse.

### BRIEF SUMMARY OF THE INVENTION

According to one aspect of the present invention, there is provided a copy-protection signal detector which detects a copy-protection signal containing a pseudo-synchronization pulse and a pseudo-auto gain control (AGC) pulse, comprising: an input terminal to which an analog video signal is entered; a pseudo-synchronization pulse detecting section which detects a pseudo-synchronization pulse from a horizontal scanning line signal during a vertical blanking period of the analog video signal entered from the input terminal; a pseudo-AGC pulse detecting section which detects a pseudo-AGC pulse from the horizontal scanning line signal during the vertical blanking period of the analog video signal entered from the input terminal; and a determining section to determine whether or not the copy-protection signal is contained in the analog video signal at the end based on detection results of the pseudo-synchronization pulse detecting section and the pseudo-AGC pulse detecting section.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a functional block diagram of an optical disk recorder using a copy-protection signal detector of the present invention.

FIG. 2 is a view showing a scanning line in one frame of a video.

FIGS. 3A and 3B are waveform charts of a copy-protection signal multiplexed on an analog video signal.

FIG. 4 is a flowchart explaining a determination operation in a copy-protection signal detector according to a first embodiment of the present invention.

FIG. 5 is a flowchart explaining a determination operation in a copy-protection signal detector according to a second embodiment of the present invention.

FIG. 6 is a flowchart explaining a determination operation in a copy-protection signal detector according to a third embodiment of the present invention.

FIG. 7 is a waveform chart of a copy-protection signal multiplexed on an analog video signal.

FIG. 8 is a flowchart explaining a determination operation in a copy-protection signal detector according to a fourth embodiment of the present invention.

FIG. 9 is a flowchart explaining a determination operation in a copy-protection signal detector according to a fifth embodiment of the present invention.

### DETAILED DESCRIPTION OF THE INVENTION

Next, detailed description will be made of a case of applying a copy-protection signal detector of the present invention to an optical disk recorder equipped with a line input terminal with reference to the accompanying drawings.

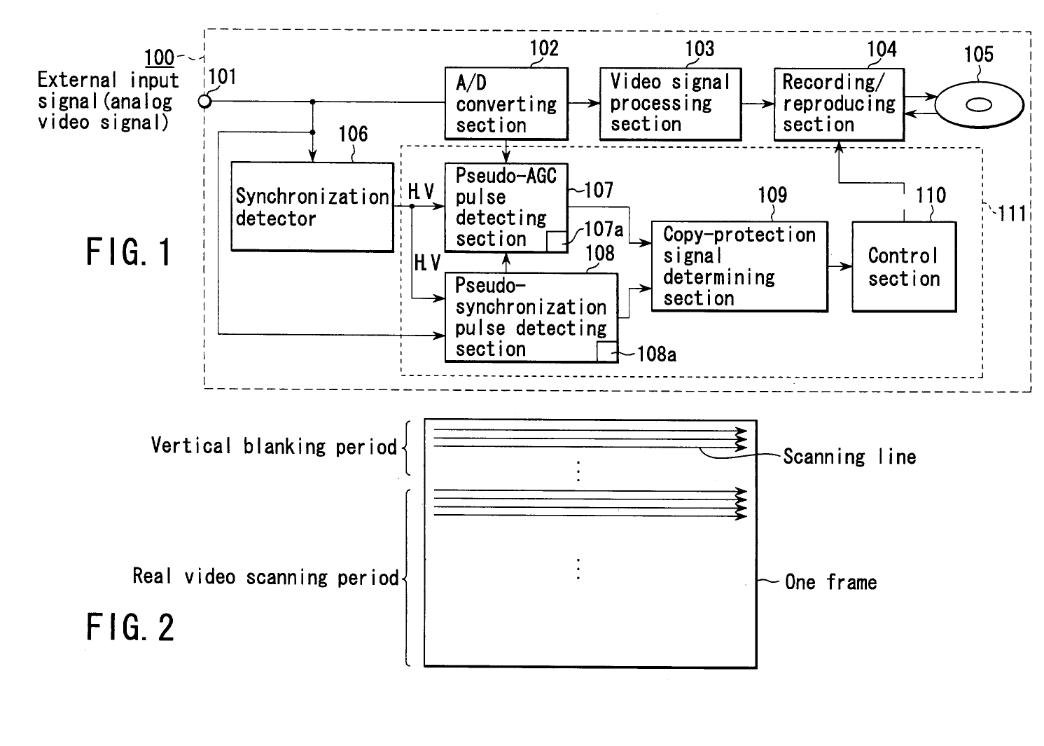

FIG. 1 is a functional block diagram of the optical disk recorder using the copy-protection signal detector of the present invention.

In FIG. 1, a reference numeral 100 denotes an optical disk recorder, 101 an input terminal to which an analog signal is entered from the outside, 102 an A/D converting section for analog/digital conversion, 103 a video signal processing section to carry out recording conversion for a digital-converted video signal, 104 a recording/reproducing section for recording the video signal on an optical disk 105 and reproducing the recorded signal, 105 the optical disk which allows recording/reproducing, 106 a synchronization detector for detecting horizontal and vertical synchronization signals from the entered analog video signal, 107 a pseudo-AGC pulse detecting section for detecting a pseudo-AGC pulse, 108 a pseudo-synchronization pulse detecting section for detecting a pseudo-synchronization signal, 109 a copy-protection signal determining section for determining presence of a copy-protection signal, and 110 a control section for controlling the entire optical disk recorder 100.

The pseudo-AGC pulse detecting section 107, the pseudo-synchronization pulse detecting section 108, the copy-protection signal determining section 109, and the control section 110 are described here as different functional blocks. However, the plurality of these functions can be realized by one microcomputer 111 (CPU for executing an actual arithmetic operation, ROM for recording programs etc., RAM used as a work area).

The A/D converting section 102 converts the analog video signal entered from the input terminal 101 from analog to digital, and outputs the digital video signal after the A/D conversion to the video signal processing section 103. Resolution of the A/D converting section 102 is, for example 8 bits, and a value of the digital video signal is 0 to 255.

The video signal processing section 103 compresses the digital video signal entered from the A/D converting section 102. That is, the video signal processing section 103 encodes the video signal in, for example an MPEG 2 video format, and outputs the encoded digital video signal to the recording/reproducing section 104.

The recording/reproducing section 104 carries out format conversion in order to record the digital video signal entered from the video signal processing section 103 on the optical disk 105, and records the format-converted digital vide signal on the optical disk 105.

The synchronization detector 106 separates horizontal and vertical synchronization signals from the analog video signal entered from the input terminal 101, and outputs the separated horizontal and vertical synchronization signals (H) and (V) to the pseudo-AGC pulse detecting section 107 and the pseudo-synchronization pulse detecting section 108. The synchronization detector 106 may also be realized by the microcomputer 111. In this case, synchronization is detected based on the video signal digitized first at the A/D converting section 102. This technology of detecting synchronization after digitization can be realized by a conventional technology.

FIG. 2 shows a scanning line in one frame of a video. A period of the predetermine number (e.g., 22) of first scanning lines in one frame is a vertical blanking period where no substantial video signals are present. Substantial video signals are scanned during a real video scanning period, and the signals of this real video scanning period are displayed on a display screen such as a CRT or an LCD.

The copy-protection signals can be multiplexed, for example on the 2nd to 19th scanning lines during the vertical blanking period. The 20th to 22nd scanning lines are used for other purposes such text broadcasting. Scanning lines for the substantial video signals are 23rd to 525th. Generally, a plurality of such scanning lines on which the copy-protection signal has been multiplexed are inserted into predetermined positions during the vertical blanking period.

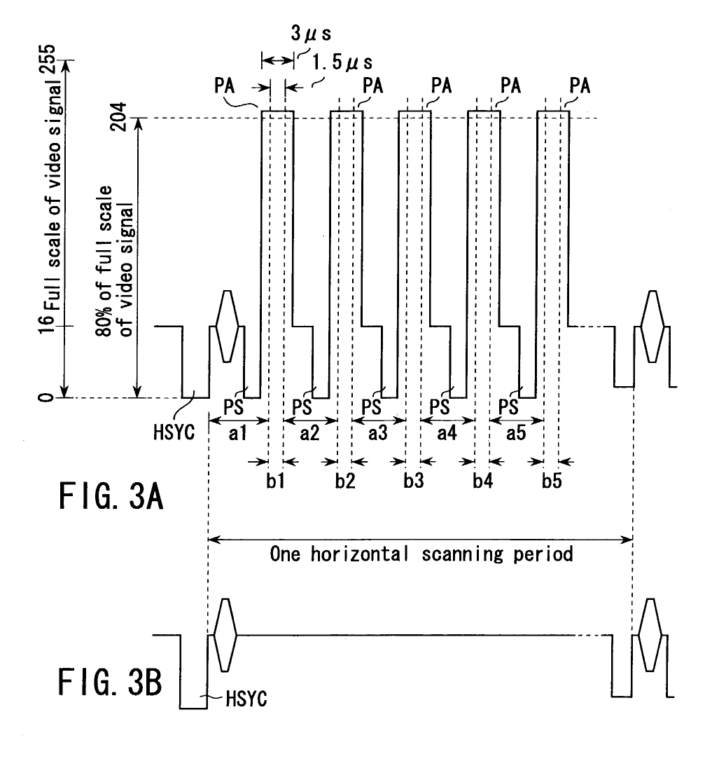

FIG. 3A shows one scanning line of the vertical blanking period, on which a copy-protection signal has been multiplexed to cause a malfunction of the AGC circuit. FIG. 3B shows a scanning line on which the copy-protection signal has not been multiplexed.

As shown in FIG. 3A, the copy-protection signal inserted into the analog video signal is constituted of a plurality of pairs of pseudo-AGC pulses PA and pseudo-synchronization pulses PS. Generally, if a signal on which such a copy-protection signal has been multiplexed by an analog recorder such as a VTR, normal luminance control of a video becomes impossible due to the pseudo-AGC pulse PA, and synchronization of the video becomes difficult due to the pseudo-synchronization pulse PS.

Referring back to FIG. 1, the pseudo-AGC pulse detecting section 107 is operated at timing based on horizontal and vertical synchronization signals entered from the synchronization detector 106. The pseudo-AGC pulse detecting section 107 includes a counter 107a to count pseudo-AGC pulses inserted into the horizontal scanning line, and determines whether pseudo-AGC pulses PA, 5 pulses being present per horizontal scanning line according to a standard, have been inserted into five continuous horizontal scanning lines or not.

The pseudo-synchronization pulse detecting section 108 is operated at timing based on the horizontal and vertical synchronization signals entered from the synchronization detector 106. The pseudo-synchronization pulse detecting section 108 includes a counter 108a to count pseudo-synchronization pulses inserted into the horizontal scanning line, and determines whether pseudo-synchronization pulses, 5 pseudo-synchronization pulses being present per horizontal scanning line, have been inserted into five continuous horizontal scanning lines or not.

The copy-protection signal determining section 109 determines whether the copy-protection signal (plurality of pairs of pseudo-AGC pulses and pseudo-synchronization pulses) is contained or not in accordance with determination results of the pseudo-AGC pulse detecting section 107 and the pseudo-synchronization pulse detecting section 108. The copy-protection signal determining section 109 determines that the copy-protection signal has been inserted when the pseudo-AGC pulses are continuously inserted into the five horizontal scanning lines and further the pseudo-synchronization pulses, 5 being present per horizontal scanning line, are inserted into the five continuous scanning line. The copy-protection signal determining section 109 outputs this determination result to the control section 110.

The control section 110 controls the recording/reproducing section 104 based on the last determination result of presence of the copy-protection signal. Upon entry of the determination result from the copy-protection signal determining section 109 indicating that the copy-protection signal is contained (copy-protected), the control section 110 stops a recording operation of the recording/reproducing section 104. Conversely, upon entry of the determination result from the copy-protection signal determining section 109 indicating that the copy-protection signal is contained, the control section 110 permits the recording operation of the recording/reproducing section 104.

Next, description will be made of how the pseudo-AGC pulse detecting section 107 detects the pseudo-AGC pulse inserted into one line during the vertical blanking period.

As shown in FIGS. 3A and 3B, because of the standard of the copy-protection signal, it is assumed that a level of the pseudo-AGC pulse PA is decided to be 80% or more of a full scale of a video signal. If a full scale value of the video signal is 255, a value of 80% of the full scale value is 204. As an example, the level of the pseudo-AGC pulse is set to 80% of the full scale of the video signal here, but it may not be always 80% according to standards.

The pseudo-AGC pulse detecting section 107 fetches the digital video signal entered from the A/D converting section 102 based on the vertical and horizontal synchronization signals from the synchronization detector 106. In the embodiment, the pseudo-AGC pulse detecting section 107 fetches the digital video signal for the scanning line into which the copy-protection signal is inserted according to the standard of the copy-protection signal.

As shown in FIGS. 3A and 3B, according to the embodiment, a width of the pseudo-AGC pulse of the copy-protection signal is about 3 μs. The pseudo-AGC pulse detecting section 107 of the present invention determines presence of the AGC pulse when values sampled in the middle periods b1 to b5 of about 1.5 μs of the period of 3 μs are all 204 or higher (80% or higher of the full scale value), and there are samples of values less than 204 in the periods a1 to a5 of the pseudo-AGC period. The counter 107a counts pseudo-AGC pulses in one horizontal scanning period, whereby how many pseudo-AGC pulses are present in one horizontal scanning period can be known.

As an example, the numbers of pseudo-AGC pulses and pseudo-synchronization signals are set to five, but the numbers may not be five according to standards.

Next, description will be made of how the pseudo-synchronization pulse detecting section 108 detects the pseudo-synchronization pulse inserted into one line during the vertical blanking period.

The pseudo-synchronization pulse detecting section 108 obtains a horizontal synchronization signal HSYC present in a predetermined position from the synchronization detector 106, and masks a real synchronization signal from the video signal entered from the input terminal 101. Then, the pseudo-synchronization pulse detecting section 108 counts pseudo-synchronization pulses present in one horizontal scanning period to check the number of synchronization pulses in one horizontal retrace line period of the video signal.

For example in the case of FIGS. 3A and 3B, the pseudo-synchronization pulse detecting section 108 counts synchronization pulses present in the latter halves of the periods a1 to a5 by the counter 108a, whereby presence of five pseudo-synchronization pulses in one horizontal retrace line period can be detected. The functions including the pseudo-AGC pulse detecting section 107 can be realized by one microcomputer 111.

Next, detailed description will be made of the operation of determining whether the copy-protection signal is contained or not in the copy-protection signal detector.

Here, the description is not made by separating the pseudo-AGC pulse detecting section 107, the pseudo-synchronization pulse detecting section 108, the copy-protection signal determining section 109, and the control section 110 from one another. However, the operation is described assuming that the microcomputer 111 (CPU for executing an actual arithmetic operation, ROM for recording programs etc., RAM used as a work area) executes a program to realize the functions.

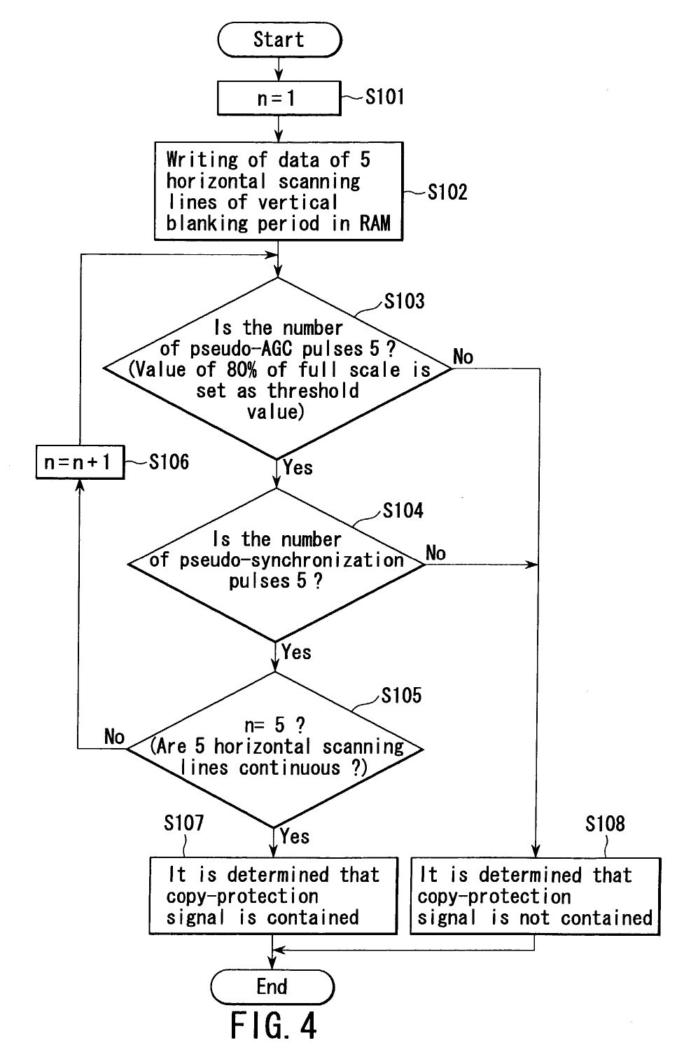

FIG. 4 is a flowchart explaining a determination operation in the copy-protection signal detector of the present invention.

In FIG. 4, the microcomputer 111 first sets a variable n to 1 (step S101). The variable n denotes the number of continuous scanning lines which satisfy conditions of the copy-protection signal. Then, the microcomputer 111 writes data of five horizontal scanning lines of the vertical blanking period in the RAM (step S102). The five horizontal scanning lines are, for example 2nd to 6th scanning lines.

Then, the microcomputer 111 sets a value of 80% of a full scale of the video signal as a threshold value, and determines whether five pseudo-AGC pulses are present or not (step S103). If Yes, the microcomputer 111 proceeds to next step S104. If No, it determines that the copy-protection signal is not contained in the entered video signal (step S108). The process of step S103 is equivalent to the function of the pseudo-AGC pulse detecting section 107.

Then, the microcomputer 111 determines whether five pseudo-synchronization pulses are present or not (step S104). If Yes, the microcomputer 111 proceeds to next step S105. If No, as in the case of step S108, it determines that the copy-protection signal is not contained in the entered video signal. The process of step S105 is equivalent to the function of the pseudo-synchronization pulse detecting section 108.

Subsequently, the microcomputer 111 determines whether a variable n is 5 or not (step S105). If n is not equal to 5 in step S105, since the conditions of steps S103 and S104 are not satisfied continuously in five horizontal scanning line periods, a next scanning line must be processed. Thus, 1 is added to the variable n (step S106) to jump to step S102. If n=5 in step S106, since the conditions of steps S103 and S105 are satisfied continuously in the five horizontal scanning lines, the copy-protection signal is contained in the entered scanning line signal. That is, copy protection of the entered video signal is determined (step S107). The process of step S107 is equivalent to the function of the copy-protection signal determining section 109.

That is, the microcomputer 111 determines that the copy-protection signal is contained in the entered video signal when:

(1) five pseudo-AGC pulses of a level of 80% of the full scale of the video signal are present in one horizontal scanning line, and five such horizontal scanning lines are continuous, and

(2) five pseudo-synchronization pulses are present in one horizontal scanning line, and five such horizontal scanning lines are continuous.

Next, a second embodiment of determination of the present invention will be described.

As described above, not limited to the 2nd to 6th scanning lines during the vertical blanking period, the copy-protection signal may be inserted into 10th to 17th, or other scanning lines. Therefore, according to the embodiment, the scanning lines into which the copy-protection signal can be inserted during the vertical blanking period, i.e., the scanning lines of 1st to 19th, are all be fetched in the RAM, and determination is made as to whether five pseudo AGC pulses and five pseudo-synchronization pulses are present or not in five continuous scanning lines.

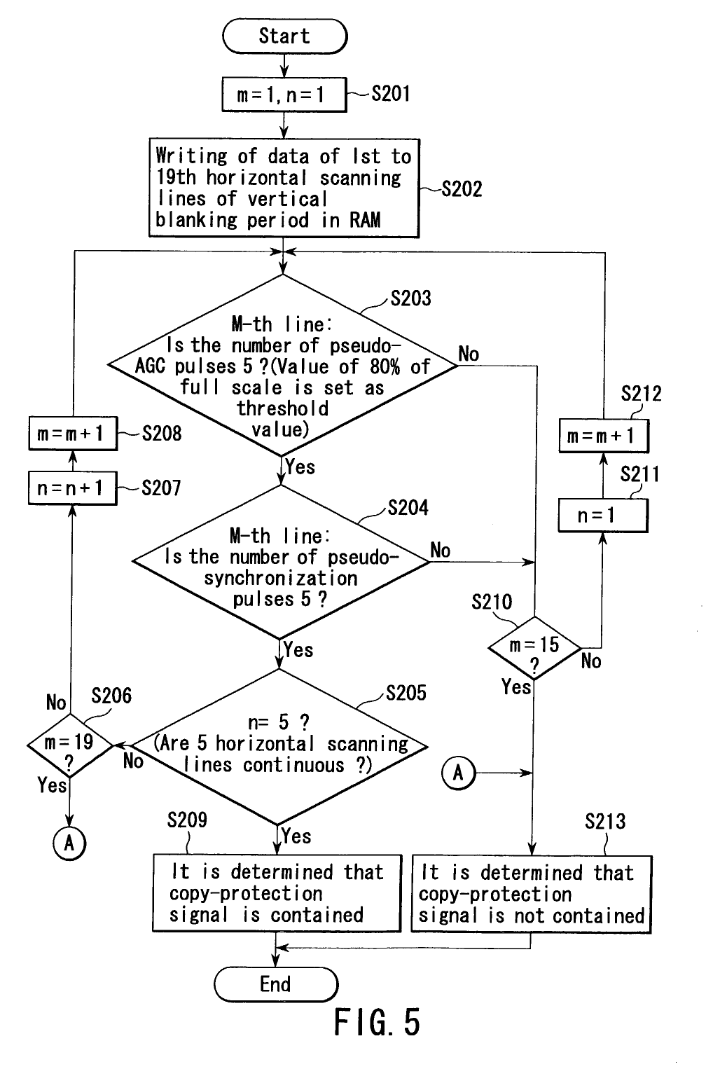

FIG. 5 is a flowchart explaining an operation of the embodiment.

The microcomputer 111 first sets variables n and m to 1 (step S201). The variable m denotes a scanning line ordinal number. Then, the microcomputer 111 writes data of 1st to 19th horizontal scanning lines of the vertical blanking period in the RAM (step S202).

The microcomputer 111 sets a value of 80% of a full scale of the video signal as a threshold value, and determines whether five pseudo-AGC pulses are present or not in the m-th scanning line (step S203). If Yes, the microcomputer 111 proceeds to next step S204. If No, the microcomputer 111 determines whether the variable m is equal to 15 or not. If not equal (No), it sets the variable n to 1, adds 1 to the variable n (S210 to S212), and proceeds to step S203. The process of step S203 is equivalent to the function of the pseudo-AGC pulse detecting section 107.

Then, the microcomputer 111 determines whether five pseudo-synchronization pulses are present or not in the m-th scanning line (step S204). If Yes, as described above, the microcomputer 111 executes steps S210 to S212.

Subsequently, the microcomputer 111 determines whether a variable n is 5 or not (step S205). If n is not equal to 5 in step S205, since the conditions of steps S203 and S204 are not satisfied continuously in five horizontal scanning line periods, a next scanning line must be processed. Thus, the microcomputer 111 verifies that the variable m is not 19 (step S206), and adds 1 to the variables n and m (steps S207, S208) to jump to step S203. If the variable m is 19, since no scanning lines on which the copy-protection signal is multiplexed are present in the frame thereafter, the microcomputer 111 determines that the copy-protection signal is not contained in the entered video signal (step S213).

If n=5 in step S205, since the conditions of steps S203 and S204 are satisfied continuously in the five horizontal scanning lines, the microcomputer 111 lastly determines that the copy-protection signal is contained in the entered scanning line signal, i.e., the copy-protection signal is contained in the entered video signal (step S209). The process of step S209 is equivalent to the function of the copy-protection signal determining section 109.

If m=15 in step S210, since there are four remaining scanning lines into which the copy-protection signal can be inserted during the vertical blanking period, step S205 is never satisfied in the frame. Thus, as in step S213, the microcomputer 111 determines that the copy-protection signal is not contained in the entered video signal.

Next, a third embodiment of the present invention will be described.

In the foregoing embodiments, the determination is made as to whether the copy-protection signal (pseudo-AGC pulse and pseudo-synchronization pulse) is contained or not in the horizontal scanning line based on the video signal of one frame. According to the present embodiment, however, determination is made in five frames. If the copy-protection signal is contained continuously in five frames, it is determined that the entered video signal is copy-protected.

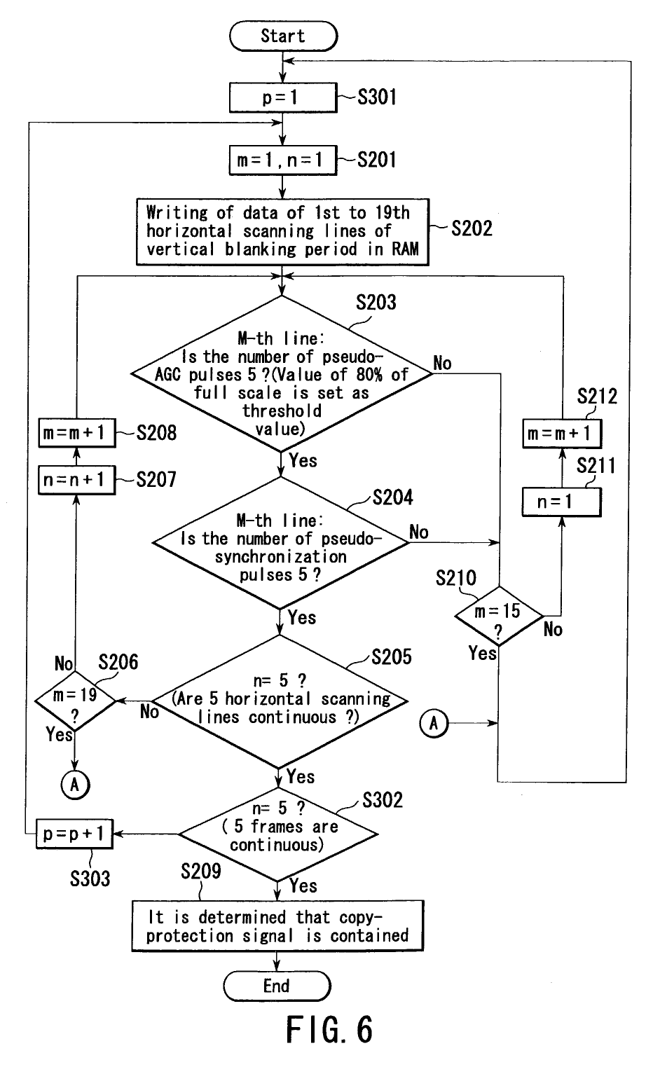

FIG. 6 is a flowchart showing the third embodiment of determination of the present invention. Compared with the second embodiment of FIG. 5, steps S301 to S303 are added and, after step S206 or S210, a flow proceeds to first step S301. Hereinafter, only operations different from those of the foregoing embodiments will be described.

In step S301, the microcomputer 211 sets a variable p to 1. The variable p denotes the number of continuous frames where the copy-protection signal is detected. In step S302, the microcomputer 211 determines whether the variable p is equal to 5 or not. If No, the microcomputer 111 adds 1 to the variable p in step S303. That is, in step S302, determination is made as to whether the copy-protection signal is detected continuously in five frames or not as in steps S203 to S205.

If Yes in step S206 or S210, the flow proceeds to step S301, where the variables p, m, n are set to 1, and data of 1st to 19th horizontal scanning lines is written in the RAM during the vertical blanking period of a next frame (step S202). As a result, the microcomputer 111 always monitors the process to determine whether the copy-protection signal is contained or not in the entered video signal during the recording operation of the recording/reproducing operation section 104.

According to the embodiment, the microcomputer 111 lastly determines that the copy-protection signal is contained in the entered video signal, i.e., the entered video signal is copy-protected when:

(1) five pseudo-AGC pulses of a level of 80% of the full scale of the video signal are present in one horizontal scanning line, and five such horizontal scanning lines are continuous,

(2) five pseudo-AGC pulses are present in one horizontal scanning line, and five such horizontal scanning lines are continuous, and

(3) five frames satisfying (1) and (2) are continuous.

Next, a fourth embodiment of the present invention will be described.

In the foregoing embodiments, a size of the pseudo-AGC pulse for the copy-protection signal is fixed to one kind, i.e., 80% of the full scale of the video signal. However, if a waveform of the analog signal is broken or noise enters, it is not always possible to obtain a value of 80% for the pseudo-AGC pulse of the copy-protection signal in the periods b1 to b5 of FIGS. 3A and 3B.

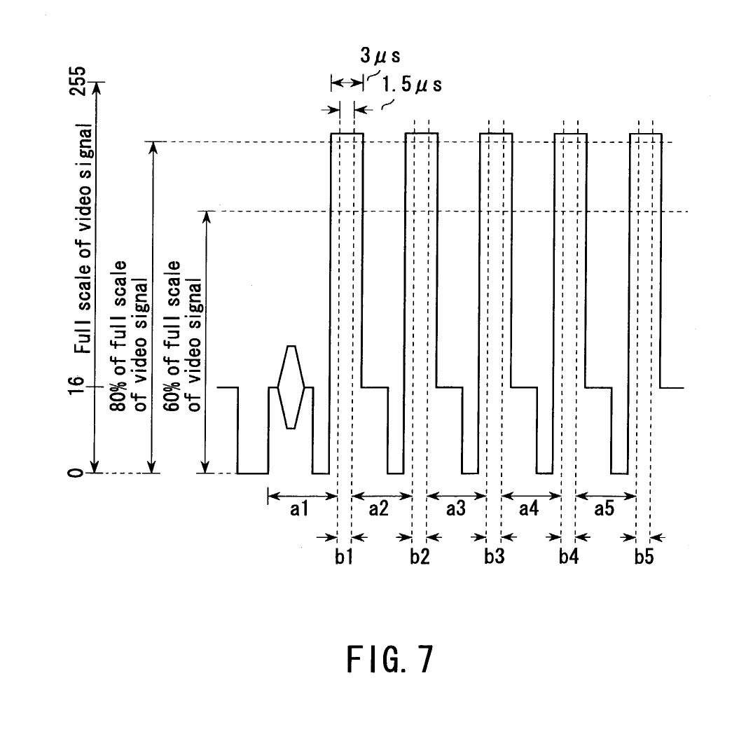

In order to prevent such a situation, according to the embodiment, sample data is compared with a threshold value of 60% of the full scale of the video signal in the periods b1 to b5 as shown in FIG. 7. It is verified that all the sample data reach 60% in the periods b1 to b5, and lower than 60% in the other periods a1 to a5. Further, it is verified that at least one sample data of the video signal reaches 80% of the full scale in the periods b1 to b5, and lower than 80% in the other periods a1 to a5. In such a case, presence of the copy-protection signal is determined.

Thus, since the pseudo-AGC pulse detecting section 107 compares the pseudo-AGC signal with the plurality of levels (60% and 80% of the full scale of the video signal) to lastly determine the presence of the pseudo-AGC signal, correct determination can be made even if a waveform of the analog video signal is broken.

Next, description will be made of the determination operation of the detector to compare the pseudo-AGC signal with the plurality of levels as the fourth embodiment as shown in FIG. 7.

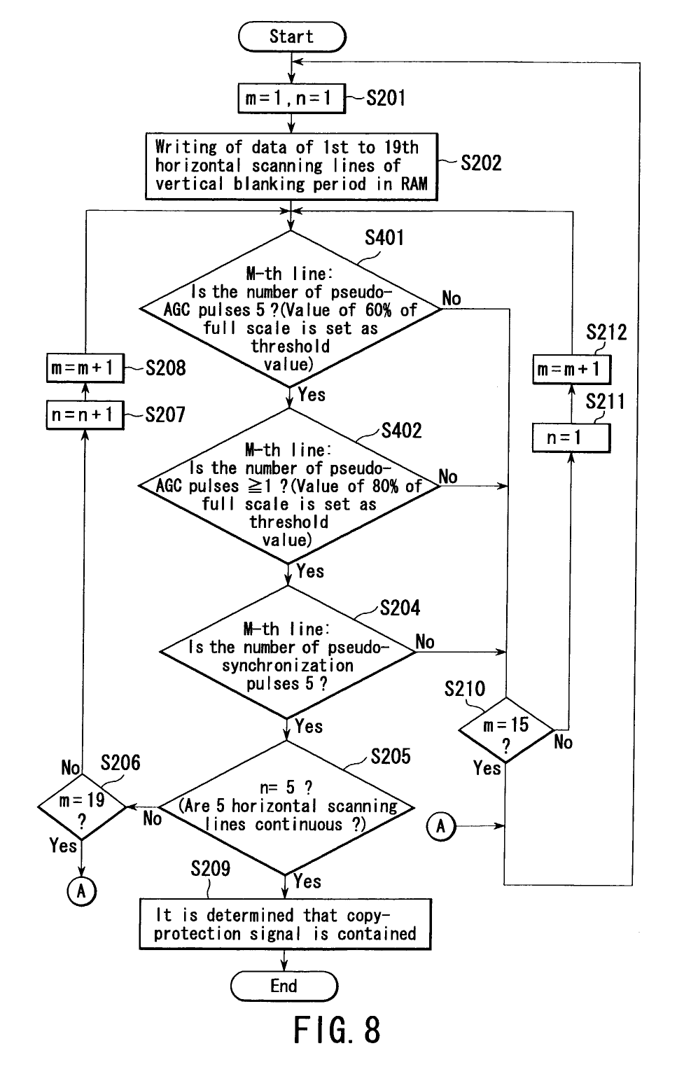

FIG. 8 is a flowchart explaining the determination operation of the copy-protection signal detector of the embodiment. Compared with the second embodiment of FIG. 5, step S203 is changed to steps S401, S402 and, after step S206 or S210, a flow proceeds to first step S301.

That is, in step S401, the microcomputer 111 sets a value of 60% of a full scale of the video signal as a threshold value, and determines whether five pseudo-AGC pulses are present or not in the m-th scanning line. If Yes in step S401, the microcomputer 111 proceeds to step S402. If No, it proceeds to step S210.

In step S402, the microcomputer 111 sets a value of 80% of a full scale of the video signal as a threshold value, and determines whether at least one pseudo-AGC pulse is present or not. If Yes in step S402, the microcomputer 111 proceeds to step S204. If No, the microcomputer 111 proceeds to step S210. The process of each of steps S401 and S402 is equivalent to the function of the pseudo-AGC pulse detecting section 107.

If Yes in step S206 or S210, the flow proceeds to step S301, where the variables p, m, n are set to 1, and data of 1st to 19th horizontal scanning lines is written in the RAM during the vertical blanking period of a next frame (step S202). As a result, the microcomputer 111 always monitors the process to determine whether the copy-protection signal is contained or not in the entered video signal during the recording operation of the recording/reproducing operation section 104. An operation thereafter is similar to that of FIG. 5, and thus description thereof will be omitted.

Thus, according to embodiment, presence of the copy-protection signal is determined by using levels of both 60% and 80% of the full scale of the video signal for the pseudo-AGC pulse. This is because while the level of the pseudo-AGC pulse is 80% or higher of the full scale of the video signal according to the standard of the copy-protection signal, not all five pulses are levels of 80% or higher. Additionally, the determination is not made by using only the threshold value of 60%, and the samples are compared with the threshold value of 80% for the purpose of preventing erroneous determination of noise as a copy-protection signal.

That is, according to the embodiment, the microcomputer 111 determines presence of the copy-protection signal when:

(1) five pseudo-AGC pulses of a level of 60% of the full scale of the video signal are present in one horizontal scanning line, and five such horizontal scanning lines are continuous,

(2) one of five pseudo-AGC pulses present in one horizontal scanning line of (1) is a level of 80% of the full scale of the video signal, and

(3) five horizontal scanning lines into which five pseudo-synchronization pulses are inserted are continuous.

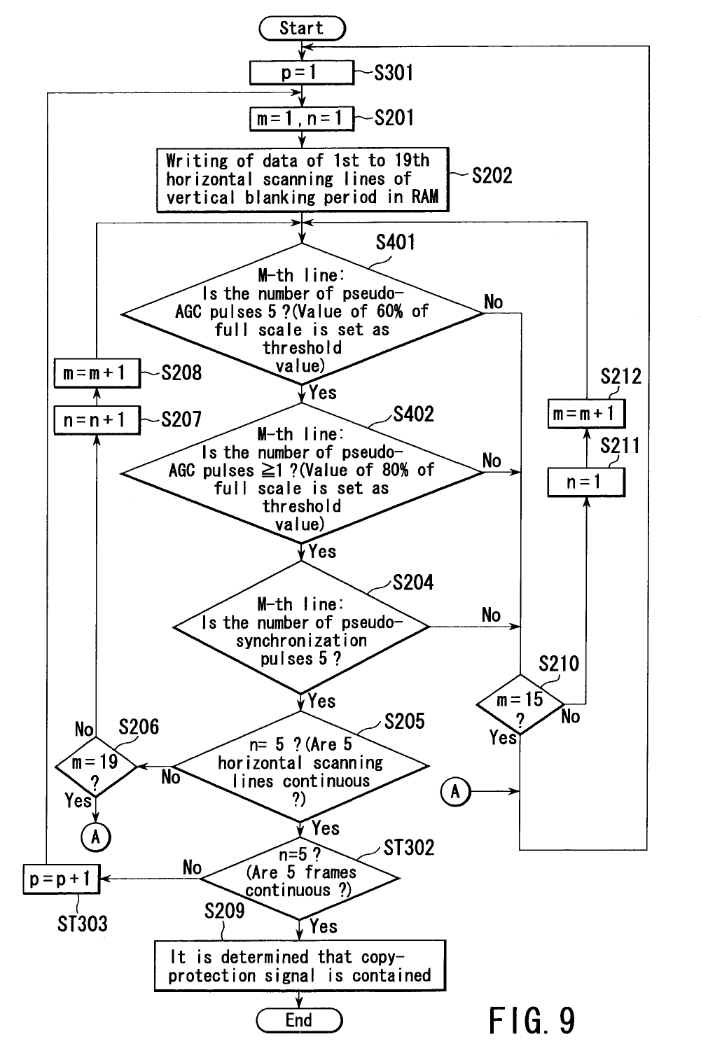

FIG. 9 is a flowchart showing a fifth embodiment of the present invention. According to the embodiment, presence of the copy-protection signal is determined when conditions similar to those of steps S401, S402, S204, S205 described above with reference to the fourth embodiment are satisfied for a plurality of continuous frames. Compared with the flowchart of FIG. 8, in the flowchart of FIG. 9, steps S301 to S303 are added. These steps S301 to S303, S206 and S210 are similar to those of FIG. 6, and thus description thereof will be omitted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A copy-protection signal detector which detects a copy-protection signal containing a pseudo-synchronization pulse and a pseudo-auto gain control (AGC) pulse, comprising:
an input terminal to which an analog video signal is entered;
a pseudo-synchronization pulse detecting section which detects a pseudo-synchronization pulse from a horizontal scanning line signal during a vertical blanking period of the analog video signal entered from the input terminal;
a pseudo-AGC pulse detecting section which detects a pseudo-AGC pulse from the horizontal scanning line signal during the vertical blanking period of the analog video signal entered from the input terminal; and
a determining section which determines whether or not the copy-protection signal is contained in the analog video signal based on detection results of the pseudo-synchronization pulse detecting section and the pseudo-AGC pulse detecting section.

2. The detector according to claim 1, further comprising:
an A/D converting section which converts the analog video signal entered from the input terminal into a digital video signal,
the pseudo-synchronization pulse detecting section and the pseudo-AGC pulse detecting section respectively detect the pseudo-synchronization pulse and the pseudo-AGC pulse based on a horizontal scanning line signal during the vertical blanking period of the digital video signal provided from the A/D converting section.

3. The detector according to claim 2, wherein the pseudo-AGC pulse detecting section detects the pseudo-AGC pulse by comparing a plurality of threshold values different from one another with the horizontal scanning line signal.

4. The detector according to claim 2, wherein the pseudo-AGC pulse detecting section comprises a first counter to detect the pseudo-AGC pulses by comparing the horizontal scanning line signal with a first threshold value and count the number of the detected pseudo-AGC pulses, and a second counter to detect the pseudo-AGC pulses by comparing the horizontal scanning line signal with a second threshold value smaller than the first threshold value and count the number of the detected pseudo-AGC pulses,
and the determining section determines that the pseudo-AGC pulse is contained in the horizontal scanning line signal when the second counter counts predetermined pseudo-AGC pulses, and the first counter counts at least one pseudo-AGC pulse.

5. The detector according to claim 1, wherein the pseudo-synchronization pulse detecting section comprises a first counter to count the pseudo-synchronization pulse contained in one horizontal scanning line signal, the pseudo-AGC pulse detecting section comprises a second counter to count the pseudo-AGC pulse contained in the one horizontal scanning line signal,
and the determining section determines that the copy-protection signal is contained in the video signal when count values of the first and second counters are both predetermined values of 2 or more.

6. The detector according to claim 5, wherein the determining section determines that the copy-protection signal is contained in the video signal when scanning lines in which the predetermined numbers of synchronization pulses and AGC pulses are counted by the first and second counters are continuous by predetermined numbers of 2 or more.

7. The detector according to claim 6, wherein the determining section determines that the copy-protection signal is contained in the video signal when frames having the predetermined number of the continuous scanning lines are continuous by a predetermined number of 2 or more.

8. A video signal recorder comprising:
an input terminal to which an analog video signal is entered;
an A/D converting section which converts the analog video signal entered from the input terminal into a digital video signal;
a compressor to compress the digital video signal converted by the A/D converting section;
a recorder to record the digital video signal compressed by the compressor on a recording medium; and
a copy-protection signal detector which detects a copy-protection signal containing a pseudo-synchronization pulse and a pseudo-AGC pulse,
the copy-protection signal detector including:
a pseudo-synchronization pulse detecting section which detects the pseudo-synchronization pulse from a horizontal scanning line signal during a vertical blanking period of the digital video signal provided from the A/D converting section;
a pseudo-AGC pulse detecting section which detects the pseudo-AGC pulse from the horizontal scanning line signal during the vertical blanking period of the digital video signal provided from the A/D converting section; and
a determining section to determine whether the copy-protection signal is contained or not in the analog video signal based on detection results of the pseudo-synchronization pulse detecting section and the pseudo-AGC pulse detecting section.

9. The recorder according to claim 8, wherein the pseudo-AGC pulse detecting section detects the pseudo-synchronization pulse by comparing a plurality of threshold values different from one another with the horizontal scanning line signal.

10. The recorder according to claim 8, wherein the pseudo-AGC pulse detecting section comprises a first counter to detect the pseudo-AGC pulses by comparing the horizontal scanning line signal with a first threshold value and count the number of the detected pseudo-AGC pulses, and a second counter to detect the pseudo-AGC pulses by comparing the horizontal scanning line signal with a second threshold value smaller than the first threshold value and count the number of the detected pseudo-AGC pulses,
and the determining section determines that the pseudo-AGC pulse is contained in the horizontal scanning line signal when the second counter counts predetermined pseudo-AGC pulses, and the first counter counts at least one pseudo-AGC pulse.

11. The recorder according to claim 8, wherein the pseudo-synchronization pulse detecting section comprises a first counter to count the pseudo-synchronization pulse contained in one horizontal scanning line signal, the pseudo-AGC pulse detecting section comprises a second counter to count the pseudo-AGC pulse contained in the one horizontal scanning line signal,
and the determining section determines that the copy-protection signal is contained in the analog video signal when count values of the first and second counters are both predetermined values of 2 or more.

12. The recorder according to claim 11, wherein the determining section determines that the copy-protection signal is contained in the analog video signal when scanning lines in which the predetermined numbers of synchronization pulses and AGC pulses are counted by the first and second counters are continuous by predetermined numbers of 2 or more.

13. The recorder according to claim 12, wherein the determining section determines that the copy-protection signal is contained in the analog video signal when frames having the predetermined number of the continuous scanning lines are continuous by a predetermined number of 2 or more.

14. A method to detect a copy-protection signal containing a pseudo-synchronization pulse and a pseudo-auto gain control (AGC) pulse, comprising the steps of:
entering an analog video signal;
detecting a pseudo-synchronization pulse from a horizontal scanning line signal during a vertical blanking period of the entered analog video signal;
detecting a pseudo-AGC pulse from the horizontal scanning line signal during the vertical blanking period of the entered analog video signal; and
determining whether the copy-protection signal is contained or not in the analog video signal based on detection results of the pseudo-synchronization pulse and the pseudo-AGC pulse.
